(19) United States
(12) Patent Application Publication
(10) Pub. No.: US 2014/0273928 A1
(43) Pub. Date: Sep. 18, 2014

(54) METHODS, SOFTWARE, AND DEVICES FOR AUTOMATICALLY VERIFYING COMPLETION OF SERVICE ORDERS FOR MOBILE DEVICES

(71) Applicant: 1666863 Ontario Inc., Toronto (CA)

(72) Inventor: Peter Dobbs, Toronto (CA)

(21) Appl. No.: 13/828,844

(22) Filed: Mar. 14, 2013

(51) Int. Cl. H04W 4/24

(52) U.S. Cl. CPC H04W 4/24
USPC 455/406

(57) ABSTRACT

Methods, software and devices for automatically verifying completion of mobile device service orders by service providers are disclosed. Service orders are transmitting to service provider, each service order requesting a change in subscribed services for one of a plurality of mobile device. Electronic records of requested changes in subscribed services are stored. Invoices are received from the service providers. Each invoice is parsed to determine invoiced services for a given mobile device. Invoiced services for the given mobile device are compared with the stored electronic records to verify completion of any stored service order for that mobile device.

### TECHNICAL FIELD

This relates to mobile devices, and more particularly to methods, software, and devices for automatically determining whether user-requested changes in subscribed services for mobile devices have been completed by service providers.

### BACKGROUND

Modern workforces often need to be equipped with wireless mobile telecommunication devices such as mobile phones, tablet devices, and the like (collectively, “mobile devices”). To this end, many employers deal with telecommunication service providers to provide employees with mobile devices and associated telecommunication services. Such services may include airtime over the service providers' wireless networks, text messaging, voicemail, call waiting, etc., and are typically provided by service providers for particular mobile devices on a subscription basis.

Software systems that allow employers to manage inventory, i.e., to order new devices or retire old devices, and to add/remove subscribed services for particular devices, are known. Some of these software systems also provide a web portal allowing employees to directly request changes to their devices and subscribed services, to suit their particular mobile telecommunication needs. Requested changes are sent to service providers for execution.

In some cases, however, service providers may fail to complete some requested changes, or make the wrong changes. Although omissions/errors made in changes to physical devices are usually readily apparent, mistakes made in changes to subscribed services may escape detection. It is particular difficult to detect such mistakes when changes to subscribed services are requested by employees, but those services are invoiced to employers. As a result of these mistakes, employers may unknowingly pay for unwanted services. While employers may make efforts to monitor or audit subscribed services for mobile devices used by their employees, such efforts may be difficult and/or expensive in organizations with a large number of employees.

### SUMMARY

According to an aspect, there is provided a computer-implemented method of verifying completion of mobile device service orders by service providers. The method comprises: transmitting a plurality of service orders to at least one service provider, each of the plurality of service orders requesting a change in subscribed services for one of a plurality of mobile devices; storing electronic records of changes in subscribed services requested by the transmitted service orders; receiving a plurality of invoices from the at least one service provider; parsing one of the plurality of invoices to determine invoiced services for a given mobile device of the plurality of mobile devices; comparing the invoiced services for the given mobile device with the stored electronic records to verify completion of any stored service order for the given mobile device; and repeating the parsing and comparing for other invoices of the plurality of invoices.

According to another aspect, there is provided a computing device for verifying completion of mobile device service orders by service providers. The computing device comprises: at least one processor; memory in communication with the at least one processor; and software code stored in the memory. The software code, when executed by the at least one processor, causes the computing device to: transmit a plurality of service orders to at least one service provider, each of the plurality of service orders requesting a change in subscribed services for one of a plurality of mobile devices; store electronic records of changes in subscribed services requested by the transmitted service orders; receive a plurality of invoices from the at least one service provider; parse one of the plurality of invoices to determine invoiced services for a given mobile device of the plurality of mobile devices; compare the invoiced services for the given mobile device with the stored electronic records to verify completion of any stored service order for the given mobile device; and repeat the parsing and comparing for other invoices of the plurality of invoice.

According to a further aspect, there is provided a computer-readable medium storing instructions which when executed adapt a computing device to: transmit a plurality of service orders to at least one service provider, each of the plurality of service orders requesting a change in subscribed services for one of a plurality of mobile devices; store electronic records of changes in subscribed services requested by the transmitted service orders; receive a plurality of invoices from the at least one service provider; parse one of the plurality of invoices to determine invoiced services for a given mobile device of the plurality of mobile devices; compare the invoiced services for the given mobile device with the stored electronic records to verify completion of any stored service order for the given mobile device; and repeat the parsing and comparing for other invoices of the plurality of invoices.

Other features will become apparent from the drawings in conjunction with the following description.

### BRIEF DESCRIPTION OF THE DRAWINGS

In the figures which illustrate example embodiments,

FIG. 1 is a network diagram illustrating a computer network, a service order processing server, service provider servers, and end-user computing devices interconnected to the network, exemplary of an embodiment;

FIG. 2 is a high-level block diagram of a computing device that may function as the service order processing server of FIG. 1;

FIG. 3 is a diagram illustrating the software organization of the service order processing server of FIG. 1;

FIG. 4 is a diagram illustrating a database schema for a database used by the service order processing server of FIG. 1;

FIG. 5 is a high-level block diagram of the modules of the service order processing software of FIG. 3, executing at the service order processing server of FIG. 1;

FIG. 6 illustrates an exemplary user interface for requesting changes in subscribed services for a mobile device;

FIG. 7 illustrates a portion of an example service provider invoice for a mobile device;

FIG. 8 illustrates a portion of another example service provider invoice for a mobile device; and

FIG. 9A/FIG. 9B is a flowchart depicting exemplary blocks performed by the service order processing software of FIG. 3.

### DETAILED DESCRIPTION

FIG. 1 illustrates a computer network and network-interconnected server 12, exemplary of an embodiment. As will become apparent, server 12 is a computing device that includes software that automatically determines whether user-requested changes in subscribed services for mobile devices have been completed by a service provider. These changes may be those requested by users employed by various organizations, equipped with mobile devices serviced by various service providers.

As illustrated, server 12 is in communication with other computing devices such as end-user computing devices 14 and service provider servers 16 through computer network 10. Network 10 could, for example, be an IPv4, IPv6, X.25, IPX compliant or similar network. Thus, network 10 could be the public Internet, or a private intranet. Network 10 may include wired and wireless points of access, and bridges to other communications networks, such as GSM/GPRS/3G/LTE or similar wireless networks. When network 10 is a public network such as the Internet, portions thereof may be secured as a virtual private network.

Example end-user computing devices 14 are illustrated. End-user computing devices 14 are conventional network-interconnected computing devices used to access data and services through a suitable HyperText Markup Language (HTML) browser or similar interface from network interconnected servers, such as server 12. Computing devices 14 may be operated by mobile devices users to request changes in subscribed services for their mobile devices by way of software executing at server 12. Computing devices 14 may also be operated by those or other users to receive notifications from software executing at server 12 upon determining whether requested changes have been completed by a service provider. Such other users could be, for example, administrators working for employers of mobile device users.

The architecture of computing devices 14 is not specifically illustrated. Each computing device 14 may include a processor, network interface, display, and memory, and may be a desktop personal computer, a laptop computing device, a network computing device, a tablet computing device, a personal digital assistant, a mobile phone, or the like. Computing devices 14 may access server 12 by way of network 10. As such, computing devices 14 typically store and execute network-aware operating systems including protocol stacks, such as a TCP/IP stack, and web browsers such as Microsoft Internet Explorer, Mozilla Firefox, Google Chrome, Apple Safari, or the like.

Example service provider servers 16 are shown. Each server 16 may be operated by a service provider. In particular, servers 16 may be operated by those service providers to receive electronic messages from server 12 containing requests to change subscribed services for mobile devices. Servers 16 may also be operated by service providers to send server 12 electronic invoices for mobile device services. The architecture of servers 16 is not specifically illustrated, but may be similar that of server 12, which is detailed below.

FIG. 2 is a high-level block diagram of a computing device that may function as server 12. As illustrated, server 12 includes one or more processors 20, network interface 22, a suitable combination of persistent storage memory 24, random-access memory and read-only memory, one or more I/O interfaces 26. Processor 20 may be an Intel x86, PowerPC, ARM processor, or the like. Network interface 22 interconnects server 12 to network 10. Memory 24 may be organized using a conventional filesystem, controlled and administered by an operating system governing overall operation of server 12. Server 12 may store in memory 24, through this filesystem, software for automatically determining whether user-requested changes in subscribed services for mobile devices have been completed by a service provider, as detailed below. Server 12 may include peripheral devices operable to load software into memory 24 from a computer-readable medium, for executing at server 12. Additional input/output peripherals such as a monitor, keyboard, mouse, scanner, printer and the like of server 12 are not specifically detailed herein. Peripheral devices may be interconnected to server 10 by one or more I/O interfaces 26.

FIG. 3 illustrates a simplified organization of example software components stored within memory 24 of server 12, as depicted in FIG. 2. As illustrated, software components includes operating system (OS) software 30, database engine 32, database 40, a Hypertext Transfer Protocol (HTTP) server application 34, a Simple Mail Transfer Protocol (SMTP) server application 36, and service order processing software 38. Server 12 executes these software components to adapt it to operate in manners of embodiments, as detailed below. Database 40 may be stored in memory 24 of server 12 using a filesystem administered by OS software 30.

OS software 30 may, for example, be a Unix-based operating system (e.g., Linux, FreeBSD, Solaris, OSX, etc.), a Microsoft Windows operating system, or the like. OS software 30 allows service order processing software 38 to access processor 20, network interface 22, memory 24, and one or more I/O interfaces 26 of server 12. OS software 30 may include a TCP/IP stack allowing server 12 to communicate with interconnected computing devices, such as computing devices 14, through network interface 22 using the TCP/IP protocol.

Database engine 32 may be a conventional relational, object-oriented or document-oriented database engine. Database engine 32 may be a SQL-based or a NoSQL database engine. Database engine 32 may be an ACID (Atomicity, Consistency, Isolation, Durability) compliant database engine or a non-ACID database engine. As such, database engine 32 may be, for example, Microsoft SQL Server, Oracle, DB2, Sybase, Pervasive, MongoDB or any other database engine known to those skilled in the art. Database engine 32 provides access to one or more databases 40, and thus typically includes an interface for interaction with OS software 30, and other software, such as service order processing software 38.

HTTP server application 34 is a conventional HTTP web server application such as the Apache HTTP Server, nginx, Microsoft IIS, or similar server application. HTTP server application 34 allows server 12 to act as a conventional HTTP server and provides a plurality of web pages of a web site, stored for example as (X)HTML or similar code, for access by interconnected computing devices such as computing devices 14. Web pages may be implemented using traditional web languages such as HTML, XHTML, Java, Javascript, Ruby, Python, Perl, PHP, Flash or the like, and stored in memory 24 at server 12.

Service order processing software 38 may include and/or generate user interfaces implemented using one of the above-noted web languages, thereby allowing those user interfaces to be accessed by way of a web browser. Such user interfaces may be provided in the form of web pages by way of HTTP server application 34 to computing devices 14 over network 10.

SMTP server application 36 is a conventional SMTP server such as Microsoft Exchange, Blackberry Exchange Server, Postfix, Sendmail or similar server application. SMTP server application 36 allows server 12 to act as a conventional SMTP server, As will become apparent, server 12 may send electronic messages containing requests to change subscribed services for mobile devices to servers 16 by way of SMTP server application 36. Server 12 may also receive electronic messages containing electronic invoices from servers 16 by way of SMTP server application 36. Server 12 may also send electronic notifications, e.g., to end-user computing devices 14, by way of SMTP server application 36 upon determining whether user-requested changes in subscribed services for mobile devices have been completed by a service provider.

As noted, server 12 includes a database 40. Database 40 may be a relational, object-oriented, or document-oriented database. As will become apparent, database 40 includes records representative of mobile device users, organizations employing those users, mobile device service providers, requests from mobile device users to change subscribed services, and invoices issued by mobile device service providers.

A simplified example organization of database 40 is illustrated in FIG. 4. As illustrated, example database 40 is organized as a plurality of tables. Specifically, database 40 includes accounts table 42, employers table 44, service providers table 46, devices table 48, service orders table 50, and invoices table 52.

Accounts table 42 includes table entries corresponding to particular mobile device services accounts for particular users (account holders). Each table entry includes an ACCOUNT_ID field uniquely identifying the account, a DEVICE_ID field uniquely identifying the particular mobile device on which subscribed services are active, an EMPLOYER_ID field uniquely identifying the account holder's employer, and a PROVIDER_ID field uniquely identifying the service provider providing services for the account. Each table entry also includes fields, USER_FIRST_NAME and USER_LAST_NAME, containing the first and last names of the account holder, and also a CONTACT_ADDRESS field containing contact information for the account holder. This contact information may, for example, be an e-mail address for the account holder. This e-mail address may be used, for example, to send electronic notification to the account holder when service order processing software 38 determines that a change in subscribed services requested by the account holder was not correctly completed.

Employers table 44 includes table entries corresponding to particular employers of the mobile device users. Each table entry includes an EMPLOYER_ID field (corresponding to the EMPLOYER_ID field in accounts table 42), an EMPLOYER_NAME field containing the name of the employer/organization, and a CONTACT_ADDRESS field containing contact information for the employer. The contact information may, for example, be an e-mail address for an administrator working for the employer. This e-mail address may be used, for example, to send electronic notification to that administrator when service order processing software 38 determines that a change in subscribed services requested by the account holder was not correctly completed. Employers table 44 may be omitted in embodiments in which all users are employees of a single employer. This may be the case, for example, when server 12 is operated by or on behalf of a particular employer.

Service providers table 46 includes table entries corresponding to particular telecommunication service providers. Each table entry includes a PROVIDER_ID field (corresponding to the PROVIDER_ID field in accounts table 42), a PROVIDER_NAME field containing the name of the service provider, and a CONTACT_ADDRESS field containing contact information for the service provider. This contact information may, for example, be an e-mail address for the service provider, or an IP address/port for a server 16 operated by that service provider. This contact information may be used, for example, to send requests to change subscribed services to that service provider. This contact information may also be used to contact the service provider when service order processing software 38 determines a change in subscribed services requested by the account holder was not correctly completed.

Devices table 48 includes table entries corresponding to particular mobile devices equipped to users. Each table entry includes a DEVICE_ID field (corresponding to the DEVICE_ID field in accounts table 42). Each table entry also include fields containing information about the device's model, subscriber identity module (SIM) number and device's hardware serial number, respectively, in fields DEVICE_MODEL, DEVICE_SIM_NO, and DEVICE_SERIAL_NO. Each table entry also includes a SUBSCRIBED_SERVICES field reflective of the subscribed services for the device. The SUBSCRIBED_SERVICES field may be a comma-delimited text string describing subscribed service (e.g., airtime, text messaging, voicemail, etc), or a sequence of numerical codes corresponding to subscribed services, as detailed below.

Service orders table 50 includes table entries corresponding to service orders, generated by service order processing software 38 and transmitted to service providers, as detailed below. Each service order contains one or more requested changes in subscribed services for a particular mobile device. As such, each table entry includes a SERVICE_ORDER_ID field uniquely identifying a particular service order, an ACCOUNT_ID field (corresponding to the ACCOUNT_ID field of accounts table 42), a PROVIDER_ID field (corresponding to the PROVIDER_ID field of service provider table 46), a SERVICE_ORDER_STATUS field containing information on whether or not the order has been successfully completed, and a DATED_ISSUED field containing information on when the service order was transmitted to the service provider.

Of note, each table entry also includes a SERVICE_CHANGE_REQUEST field containing information on the particular change(s) in subscribed services requested. This field may, for example, be a text string describing the requested change. For example, a request to change subscribed from 100 minutes to 200 minutes may be described by the following text string: “REMOVE_AIRTIME 100, ADD AIRTIME 200”. Similarly, a request to remove voicemail service may be described by the following text string: “REMOVE VOICEMAIL”. Multiple changes may be concatenated into a single text string, and stored in the SERVICE_CHANGE_REQUEST field.

In some embodiments, each service offered by service providers may be identified using a unique numerical code. These numerical codes could be pre-defined codes, assigned by the operator of server 12 or assigned by particular service providers. These numerical codes may correspond to, or include industry-standard codes (e.g., wireless carrier SOC codes). Thus, service orders table 50 may contain SERVICE_CHANGE_REQUEST fields referring to services using these numerical codes. For example, suppose that the numerical code for 100 minutes of airtime is “001” and the numerical code for 200 minutes of airtime is “002”. Using these numerical codes, a request to change subscribed airtime from 100 minutes to 200 minutes may be described by the string “REMOVE 001, ADD 002”. Conveniently, use of such numerical codes may allow differing naming conventions used by various service providers to be harmonized. Use of such numerical codes may also allow for more compact storage of data in database 40.

In some embodiments, a SERVICE_CHANGE_REQUEST field may contain not the requested change, but rather a list of subscribed services, as changed. For example, suppose that a user's subscribed services included the following: AIRTIME 100, 3-WAY CALLING, CALLER DISPLAY, VOICEMAIL, 2-GB DATA, UNLIMITED TEXT MESSAGES, and that subscriber made a request to change subscribed airtime from 100 minutes to 200 minutes. This request may be stored in a SERVICE_CHANGE_REQUEST field as the following string: “AIRTIME 200, 3-WAY CALLING, CALLER DISPLAY, VOICEMAIL, 2-GB DATA, UNLIMITED TEXT MESSAGES”, which lists all subscribed services and reflects the requested change. As noted, in some embodiments, services may be referenced using numerical codes. Thus, a list of all subscribed services may be represented as a sequence of such numerical codes (e.g., 002, 046, 130, 300, 212, 850 . . . ).

Invoices table 52 includes table entries corresponding to invoices received from service providers and processed at server 12, as detailed below. Each table entry includes an INVOICE_ID field uniquely identifying a particular invoice, an ACCOUNT_ID field (corresponding to the ACCOUNT_ID field of accounts table 42) a PROVIDER_ID field (corresponding to the PROVIDER_ID field of service provider table 46), and a DATED_ISSUED field containing information on when the invoice was issued by the service provider.

Of note, each table entry also includes an INVOICED_SERVICES field containing information on subscribed services charged in the invoice. This field may, for example, be a comma-delimited text string describing invoiced services. For example, invoiced services for an example invoice may be described by the following text string: “AIRTIME 100, 3-WAY CALLING, CALLER DISPLAY, VOICEMAIL, 2-GB DATA, UNLIMITED TEXT MESSAGES”. In some embodiments, INVOICED_SERVICES fields may identify invoiced services using the same numerical codes as those used in SERVICE_CHANGE_REQUEST fields (and SUBSCRIBED_SERVICES fields).

Service order processing software 38 adapts server 12, in combination with database engine 32, database 40, OS software 30, HTTP server application 34, and SMTP server application 36 to function in manners exemplary of embodiments, as detailed below.

In the embodiment depicted in FIG. 5, service order processing software 38 includes order generating module 54, invoice processing module 56, and order verifying module 58. These modules may be written using conventional computing languages such as C, C++, C#, Perl, JavaScript, Java, Visual Basic or the like. These modules may be in the form of executable applications, scripts, or statically or dynamically linkable libraries. The function of each of these modules is detailed below.

Order generating module 54 allows mobile device users to request changes in subscribed services for their mobile devices, and transmits those requests to service providers for execution. To this end, order generating module 54 includes a set of user interfaces taking the form of one or more web pages, which may be provided to users operating computing devices 14 by way of HTTP server application 34. In this way, order generating module 54 may provide a self-serve web portal that allows mobile device users to tailor subscribed services to suit their particular mobile telecommunication needs. Access to this web portal may be secured using login credentials. Users may be identified by way of an ACCOUNT_ID, as stored in accounts table 42.

FIG. 6 depicts an example of one such user interface, exemplary of an embodiment. As shown, this user interface may be manipulated by a mobile device user to request changes in subscribed services for the user's mobile device. Order generating module 54 may populate this user interface with information relating to the particular user, the user's mobile device subscription account, the user's mobile device, and currently subscribed services, as retrieved from database 40 using database engine 32. In particular, this user interface lists currently subscribed services (as stored in the SUBSCRIBED_SERVICES field of devices table 48), and provides users with the ability to request removal of any of those services. Similarly, this user interface lists new services, and provides users with the ability to request addition of these new services to replace or supplement currently subscribed services.

The particular user interfaces provided by order generating module 54 may be tailored to suit particular employees. For example, employees having particular job functions or particular seniority could be granted access to different service options.

In some embodiments, order generating module 54 may include similar user interfaces allowing employer administrator to request changes to subscribed services on behalf of mobile device users (employees). Such changes could be requested for many users simultaneously, e.g., for the entire organization or an entire department within the organization.

In some embodiments, order generating module 54 may include other user interfaces, not specifically detailed herein, which allow users to order/retire mobile devices, to order hardware accessories for their mobile devices, and to review past requests.

Once order generating module 54 receives a requested change in subscribed services for a particular mobile device, order generating module 54 generates a service order for the requested change. As noted, each service order is a record of one or more requested changes in subscribed services for a particular mobile device. Order generating module 54 assigns the newly-generated service order a unique numerical identifier, corresponding to the SERVICE_ORDER_ID field of service order table 50. Order generating module 54 stores a record of the newly-generated service order in service order table 50 by updating database 40 using database engine 32.

Order generating module 54 transmits generated service orders to a service provider server 16 operated by the appropriate service provider. The appropriate service provider for a given user's mobile device is identified by way of the PROVIDER_ID stored in accounts table 42 of database 40. The service provider's address for transmitting generated service orders is retrieved from the CONTACT_ADDRESS field of service providers table 46 of database 40. Service orders may be transmitted to service provider servers 16 by way of SMTP server application 36.

In other embodiments, service orders may be transmitted to service provider servers 16 by way of HTTP messages. For example, service orders may be provided to server 16 by making HTTP requests to web services offered at server 16. Similarly, service orders may be provided to server 16 by offering web services at server 12 using, e.g., HTTP server application 34. In these embodiments, HTTP messages may optionally be secured using the HTTPS protocol.

In some embodiments, order generating module 54 may seek an employer's approval of the requested change before transmitting a service order. To this end, order generating module 54 may transmit an approval request to one or more designated administrators, for example, by way contact information stored in the CONTACT_ADDRESS field of employers table 44 in database 40.

After a service order has been transmitted to a service provider, the SERVICE_ORDER_STATUS field in the entry of service order table 50 for that service order is set to “TRANSMITTED.”

In some embodiments, order generating module 54 may receive confirmation of receipt of a service order from the service provider. In these embodiments, once such confirmation has been received, the SERVICE_ORDER_STATUS field for that confirmed service order is set to “RECEIVED”. Optionally, when such confirmation has not been received after a pre-defined period, order generating module 54 may re-transmit the service order.

In some embodiments, order generating module 54 also updates the SUBSCRIBED_SERVICES field for a given mobile device in devices table 48 to reflect the requested change in subscribed services for that mobile device. Optionally, order generating module 54 may wait for the service provider's confirmation of receipt of the service order before updating the SUBSCRIBED_SERVICES field.

Invoice processing module 56 processes invoices received from service providers to determine invoiced services for mobile devices. Invoices may be received from service providers periodically, e.g., monthly or quarterly. Each invoice may contain charges for one or more mobile devices. In some cases, a single invoice may contain all charges for all the mobile devices of an organization.

Invoices may be received from one or more service providers in several disparate formats. For example, invoices may be received in an electronic format suitable for parsing, such as Extensible Markup Language (XML) format, HTML format, comma-separated values (CSV) format, or Portable Document Format (PDF), Microsoft Excel (XLS/XLSX) format, JavaScript Object Notation (JSON) format, or the like. Other suitable formats will be apparent to those of ordinary skill in the art.

Electronic invoices may conform to industry standards for Electronic Data Interchange (EDI), such as the United Nation's EDIFACT standard governing encoding of electronic invoices.

Invoices may also be received as electronic images in Graphics Interchange Format (GIF), Tagged Image File Format (TIFF), or the like. Thus, some embodiments of invoice processing module 56 include optical character recognition (OCR) functionality to convert images into machine-recognized text suitable for parsing.

Invoices may also be received in paper form. Paper invoices may be scanned at server 12 or another computing devices interconnected to server 12 (not shown) to generate electronic images of those invoices. These images may then be converted into text suitable for parsing using an OCR process.

Invoices may identify invoiced services by way of the unique numerical codes assigned to each of those services.

Invoice processing module 56 includes one or more parsers suitable for parsing invoice text. A parser suitable for parsing PDF invoices is, for example, PDFBox, distributed by the Apache Software Foundation (Forest Hill, Md., U.S.A.). A parser suitable for parsing XML invoices is, for example, Xerces, also distributed by the Apache Software Foundation. Other parsers suitable for parsing invoices in other formats will be apparent to those of ordinary skill in the art.

FIG. 7 and FIG. 8 each illustrate a portion of an exemplary invoice received from a service provider. As shown, each invoice includes particulars of the account being invoiced, e.g., an account number and the name of the account holder. Each invoice also includes a list of subscribed services.

Invoice processing module 56 parses invoices to identify the particular account being invoiced, corresponding, for example, to the ACCOUNT_ID in accounts table 42, as well as to identify services that have been invoiced. Invoice processing module 56 generates a text string describing the invoiced services (corresponding to the INVOICED_SERVICES field of invoice table 52). For the invoice shown in FIG. 7, the following text string may be generated: “AIRTIME 100, 3-WAY CALLING, CALLER DISPLAY, VOICEMAIL, 2-GB DATA, UNLIMITED TEXT MESSAGES”. Similarly, for the invoice shown in FIG. 8, the following text string may be generated: “AIRTIME 100, 3-WAY CALLING, CALLER DISPLAY, VOICEMAIL, 2-GB DATA, 200 TEXT MESSAGES”.

As noted, in some embodiments, services may be identified using unique numerical codes. In these embodiments, invoice processing module 56 may instead generate an appropriate sequence of numerical codes to represent invoiced services, as parsed.

Invoice processing module 56 generates a record of the invoice including a unique numerical identifier for the invoice (corresponding to the INVOICE_ID field of invoice table 52), and a list of invoiced services, as parsed. Invoice processing module 56 stores this record in invoice table 52 by updating database 40 using database engine 32.

Order verifying module 58 verifies that service orders transmitted to service providers have been completed. To this end, order verifying module 58 compares invoiced services for a given mobile device, as determined by invoice processing module 56, with stored service orders for that mobile device, as generated/transmitted by order generating module 54. Order verifying module 58 may retrieve stored records of invoiced services and/or records of transmitted service orders from database 40 by way of database engine 32. When a service provider has made an error/omission in completing a change requested in a service order, the error/omission may be detected by the comparison performed by order verifying module 58.

By way of example only, suppose that a user John Doe requested a change for his mobile device to increase the number of subscribed text messages from 200 to “unlimited”, and that a service order corresponding to this request was sent by order generating module 54 to the service provider for his mobile device. Such a request may, for example, be stored in the corresponding SERVICE_CHANGE_REQUEST field as “REMOVE 200 TEXT MESSAGES, ADD UNLIMITED TEXT MESSAGES”. Suppose also that in the next invoicing cycle, the service provider issued an invoice as depicted, for example, in FIG. 7. As determined by invoice processing module 56, the list of invoiced services for this invoice would contain the entry “UNLIMITED TEXT MESSAGES”. Upon comparing the list of invoiced services to the stored service order for John Doe's mobile device, order verifying module 58 would determine that the change he requested was successfully completed.

In a separate example, suppose that another user Jane Doe made the same request for her mobile device, and the service provider for her mobile device subsequently issued an invoice as depicted, for example, in FIG. 8. As determined by invoice processing module 56, the list of invoiced services for this invoice would contain the entry “200 TEXT MESSAGES”. Upon comparing the list of invoiced services to the stored service order for Jane Doe's mobile device, containing the entry “UNLIMITED TEXT MESSAGES”, order verifying module 58 would determine that the change she requested was not successfully completed. This may indicate an error made by the service provider, or that the service order was lost in transit.

Alternatively, if the list of invoiced services for Jane Doe's mobile device contained an entry “AIRTIME 400”, order verifying module 58 would determine that an incorrect change had been made.

In some embodiments, order verifying module 58 may accommodate normal processing delays by taking into account the time elapsed between when a service order was transmitted to a service provider (as stored in the DATA_ISSUED field of service orders table 50) and when a subsequent invoice was issued (as stored in the DATED_ISSUED field of invoices table 52). In such embodiments, order verifying module 58 determines that an error has occurred only if the time elapsed exceeds a pre-defined threshold.

Upon determining that a service order has been successfully executed by a service provider, order verifying module 58 updates the SERVICE_ORDER_STATUS field in service orders table 50 to indicate completion, e.g., by changing the value of the field to “COMPLETED”. In some embodiments, order verifying module 58 simply deletes table entry for completed service order.

In contrast, when order verifying module 58 determines that an error has occurred in executing a service order, the value of the SERVICE_ORDER_STATUS field for that service order may be changed to “ERROR”.

Order verifying module 58 also notifies relevant stakeholders of the error. These stakeholders are pre-defined and may include the mobile device user, that user's employer, and/or the service provider. In some embodiments, order verifying module 58 sends these notifications by way of SMTP server 36, using contact information stored in database 40 (e.g., the respective CONTACT_ADDRESS fields of accounts table 42, employers table 44, or service providers table 46). In some embodiments, the service order that was not correctly completed may be automatically retransmitted to the service provider.

The operation of service order processing software 38 is further described with reference to the flowchart illustrated in FIG. 9A and FIG. 9B.

Service order processing software 38 performs blocks S900 and onward at server 12. At block S902, a user interacts with a web interface presented by order generating module 54 to request one or more changes in subscribed services for a mobile device. Order generating module 54 receives the request changes, e.g., by way of HTTP server 34. Order generating module 54 identifies the user and the user's mobile device by way of a unique account identifier (corresponding to the ACCOUNT_ID field of accounts table 42 of database 40).

Next, at block S904, order generating module 54 generates a service order reflective of the requested change(s). At block S906, order generating module 54 identifies the appropriate service provider for the user's mobile device based a SERVICE_ID stored in accounts table 42. Then, order generating module 54 electronically transmits the generated service order to the identified service provider, e.g., by way of SMTP server 36 or HTTP server 34. At block S908, order generating module 54 stores a record of the transmitted service order in service orders table 50 of database 40.

Blocks S902 through S908 may be repeated for each request to change subscribed services, received from a plurality of users for their respective mobile devices.

At block S910, invoice processing module 56 receives one or more invoices for mobile device services from one or more service providers. As noted, invoices may be received in several disparate formats, and may be received in both electronic and paper forms.

Invoice processing module 56 processes each received invoice. Invoices, when in paper format, are scanned to generate electronic images of those invoices. Optical character recognition is performed on scanned images or invoices received in an image format to convert those invoice images into machine-recognized text suitable for parsing.

At block S912, invoice processing module 56 parses a received invoice to determine, for each mobile device included in the invoice, the mobile device user's account number (corresponding to the ACCOUNT_ID field of accounts table 42) as well as each subscribed service charged in the invoice for that mobile device. Invoice processing module 56 stores a record of each invoice processed in invoice table 52 of database 40.

At block S914, for each mobile device included in the invoice, invoice processing module 56 determines whether or not there are any outstanding service orders for that mobile device. This determination is made by querying database 40 for entries in service order table 50 having an ACCOUNT_ID field matching the mobile device's user account number and a SERVICE_ORDER_STATUS field with a value of “TRANSMITTED” or “CONFIRMED”. If no outstanding service orders exist, then invoice processing module 56 moves on to the next invoice and execution returns to block S912.

If, however, an outstanding service order exists, execution continues to block S916. At block S916, for a given mobile device, order verifying module 58 compares invoiced services with the change requested in the outstanding service order to verify completion of that change.

At block S918, based on the above comparison, order verifying module 58 determines whether or not the outstanding service order was completed successfully. If order verifying module 58 determines that the service order was completed successfully, then the value of the SERVICE_ORDER_STATUS field for that service order is set to “COMPLETED” and execution moves on to the next invoice at block S912. However, if order verifying module 58 determines that the service order was not completed successfully, then the value of the SERVICE_ORDER_STATUS field for that service order is set to “ERROR” and execution progresses to block S920.

At block S920, order verifying module 58 sends electronic notifications of the detected error to all appropriate stakeholders, e.g., by way of SMTP server 36. As noted, such stakeholders may include the user of the given mobile device, the user's employer and the service provider for that mobile device. After order verifying module 58 sends electronic notifications to stakeholders, execution moves on to the next invoice at block S912. Execution ends when there are no more invoices to process.

Of course, the above described embodiments are intended to be illustrative only and in no way limiting. The described embodiments are susceptible to many modifications of form, arrangement of parts, details and order of operation. For example, software (or components thereof) described at server 12 may be hosted at several devices. Software implemented in the modules described above could be implemented using more or fewer modules. The invention is intended to encompass all such modification within its scope, as defined by the claims.

What is claimed is:

1. A computer-implemented method of verifying completion of mobile device service orders by service providers, said method comprising:
transmitting a plurality of service orders to at least one service provider, each of said plurality of service orders requesting a change in subscribed services for one of a plurality of mobile devices;
storing electronic records of changes in subscribed services requested by said transmitted service orders;
receiving a plurality of invoices from said at least one service provider;
parsing one of said plurality of invoices to determine invoiced services for a given mobile device of said plurality of mobile devices;
comparing said invoiced services for said given mobile device with said stored electronic records to verify completion of any stored service order for said given mobile device; and
repeating said parsing and comparing for other invoices of said plurality of invoices.

2. The method of claim 1, further comprising:
receiving a request for said change in subscribed services for a mobile device of said plurality of mobile devices from a user.

3. The method of claim 1, further comprising:
upon said verifying, determining that a particular service order for said given mobile device was not completed successfully.

4. The method of claim 3, further comprising:
sending notification to a pre-defined address that said particular service order was not completed successfully.

5. The method of claim 4, wherein said pre-defined address belongs to a user of said given mobile device.

6. The method of claim 4, wherein said pre-defined address belongs to said service provider for said given mobile device.

7. The method of claim 3, further comprising:
retransmitting said particular service order to said service provider for said given mobile device.

8. The method of claim 1, further comprising:
upon said verifying, determining that a particular service order for said given mobile device was completed successfully.

9. The method of claim 8, further comprising:
storing an indicator of successful completion of said particular service order.

10. The method of claim 8, further comprising:
deleting said electronic record of said particular service order.

11. The method of claim 1, wherein said plurality of invoices are received from a plurality of service providers.

12. The method of claim 1, wherein said plurality of invoices are received in a plurality of disparate formats.

13. The method of claim 1, wherein at least one of said plurality of invoices is received as Portable Document Format (PDF) document, a Hypertext Markup Language (HTML) document, an Extensible Markup Language (XML) document, a Microsoft Excel (XLS/XLSX) document, or a JavaScript Object Notation (JSON) document.

14. The method of claim 1, wherein at least one of said plurality of invoices is received as digital image.

15. The method of claim 14, further comprising:
performing optical character recognition at least one of said plurality of invoices.

16. The method of claim 1, further comprising:
storing electronic records of subscribed services for said plurality of mobile devices.

17. The method of claim 16, further comprising:
updating said electronic records of subscribed services to reflect said requested changes in subscribed services.

18. The method of claim 1, further comprising:
receiving confirmation of receipt of a particular service order of said plurality of service orders from said at least one service provider.

19. The method of claim 1, wherein said transmitting comprises sending at least one SMTP message.

20. The method of claim 1, wherein said transmitting comprises sending at least one HTTP message.

21. A computing device for verifying completion of mobile device service orders by service providers, said computing device comprising:
at least one processor;
memory in communication with said at least one processor; and
software code stored in said memory, which when executed by said at least one processor causes said computing device to:
transmit a plurality of service orders to at least one service provider, each of said plurality of service orders requesting a change in subscribed services for one of a plurality of mobile devices;
store electronic records of changes in subscribed services requested by said transmitted service orders;
receive a plurality of invoices from said at least one service provider;
parse one of said plurality of invoices to determine invoiced services for a given mobile device of said plurality of mobile devices;
compare said invoiced services for said given mobile device with said stored electronic records to verify completion of any stored service order for said given mobile device; and
repeat said parsing and comparing for other invoices of said plurality of invoice.

22. A computer-readable medium storing instructions which when executed adapt a computing device to:
transmit a plurality of service orders to at least one service provider, each of said plurality of service orders requesting a change in subscribed services for one of a plurality of mobile devices;
store electronic records of changes in subscribed services requested by said transmitted service orders;
receive a plurality of invoices from said at least one service provider;
parse one of said plurality of invoices to determine invoiced services for a given mobile device of said plurality of mobile devices;
compare said invoiced services for said given mobile device with said stored electronic records to verify completion of any stored service order for said given mobile device; and
repeat said parsing and comparing for other invoices of said plurality of invoices.
